(19) United States
(12) Patent Application Publication
(10) Pub. No.: US 2022/0221087 A1
(43) Pub. Date: Jul. 14, 2022

(54) HELICALLY WOUND PIPE AND RELATED METHOD

(71) Applicant: CONTECH ENGINEERED SOLUTIONS LLC, West Chester, OH (US)

(72) Inventors: Roger Bradley Evans, Auburn, AL (US); Michael Harold Stoltz, Ackworth, GA (US)

(21) Appl. No.: 17/144,230

(22) Filed: Jan. 8, 2021

(51) Int. Cl. F16L 9/16; F16L 9/147

(52) U.S. Cl. CPC F16L 9/165; F16L 9/147

(57) ABSTRACT

A pipe includes an elongate strip wound into a tubular pipe form with the upper surface and the ribs at an exterior of the tubular pipe form, and with a first portion of a first side overlapping a first portion of a second side along a helical joint. A plastic seam weld is applied between the overlapping first portions for bonding the overlapping first portions together. A plastic overweld extends over the overlapping first portions and over both a second portion of the first side and a second portion of the second side. The second portion of the first side is adjacent to the first portion of the first side and does not overlap with any part of the second side, and the second portion of the second side is adjacent to the first portion of the second side and does not overlap any part of the first side.

### TECHNICAL FIELD

This application relates generally to ribbed pipe structures and, more specifically, to helically wound ribbed pipe structures with a helical seam.

### BACKGROUND

Plastic pipes can be made by helically winding a plastic strip having a series of spaced apart upstanding ribs extending longitudinally of the strip, either at room temperature or at an elevated temperature where the plastic becomes more flexible. U.S. Pat. No. 7,004,202, the entirety of which is incorporated herein by reference, describes a composite strip having upstanding plastic ribs encasing an elongate reinforcing member. Per FIG. 1, the helical winding brings together opposed sides 10, 12 of the strip in an overlapping manner to form a helical joint, which overlap can be bonded using a plastic seam weld 14. FIG. 1 illustrates the typical plastic seam weld 14 of the helical seam, with the plastic seam weld material shown in crosshatch. Some of the seam weld material is typically squeezed out beyond the overlapping portions as shown. Under extreme conditions (e.g., improper pipe handling or improper backfilling atop the pipe), pipe wall fracture alongside the helical joint may occur, as reflected by fracture 15.

It would be desirable to provide a helically wound pipe with a helical joint having improved performance under extreme conditions.

### SUMMARY

In one aspect, a pipe includes an elongate composite plastic strip having a base portion with an upper surface and a lower surface, a plurality of ribs extending upward from the upper surface of the base portion, each rib formed by a reinforcement strip within plastic material, the composite plastic strip having a first side and a second side, wherein the composite plastic strip wound into a tubular pipe form with the upper surface and the ribs at an exterior of the tubular pipe form, with a first portion of the first side overlapping a first portion of the second side along a helical joint, and with a plastic seam weld applied between the overlapping first portions for bonding the overlapping first portions together. A plastic overweld extends over the overlapping first portions of the first side and the second side and over both a second portion of the first side and a second portion of the second side, wherein the second portion of the first side is adjacent to the first portion of the first side and does not overlap with any part of the second side, and wherein the second portion of the second side is adjacent to the first portion of the second side and does not overlap any part of the first side.

In another aspect, a method of manufacturing helically ribbed pipe involves: using an elongate composite plastic strip having a base portion having an upper surface and a lower surface, a plurality of ribs extending upward from the upper surface of the base portion, each rib formed by a reinforcement strip within plastic material, the composite plastic strip having a first side and a second side; helically wrapping the composite plastic strip into a tubular pipe form with the upper surface and the ribs at an exterior of the tubular pipe form and with a first portion of the first side overlapping a first portion of the second side at a helical joint, and, during the wrapping, applying a plastic seam weld between the overlapping first portions for bonding the overlapping first portions; applying pressure to the overlapping first portions of the first side and the second side to compress the plastic seam weld; and after the application of the pressure, applying a plastic overweld that extends over the overlapping first portions of the first side and the second side and over both a second portion of the first side and a second portion of the second side, wherein the second portion of the first side is adjacent to the first portion of the first side and does not overlap with any part of the second side, and wherein the second portion of the second side is adjacent to the first portion of the second side and does not overlap any part of the first side.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 shows a prior art pipe section showing a helical pipe joint for a prior art pipe formed by helical winding of a composite plastic strip;

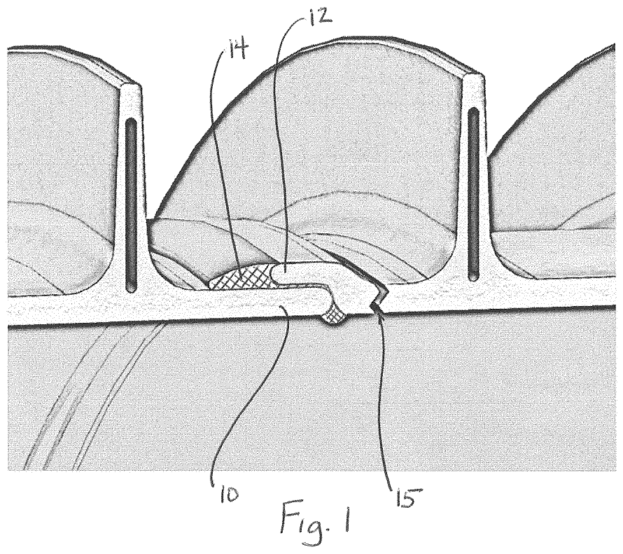

FIG. 2 shows a pipe section of a pipe according to the present application;

FIG. 3 shows the pipe section of FIG. 2, but with a pipe body wall fracture covered by the overweld;

FIG. 4 shows a pipe section of another pipe according to the present application;

FIG. 5 shows a pipe section of another pipe according to the present application; and

FIG. 6 shows a schematic depiction of one embodiment of a winding cage set-up for formation of a pipe according to the present application.

### DETAILED DESCRIPTION

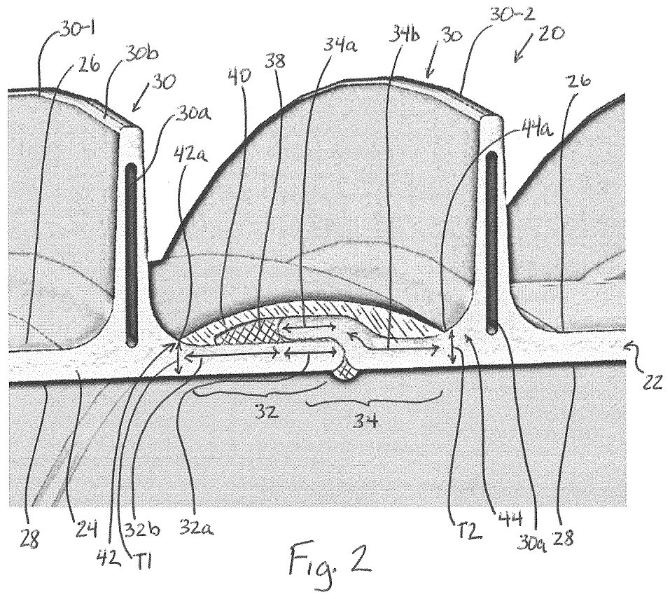

Referring to FIG. 2, a pipe 20 is formed of an elongate composite plastic strip 22 having a base portion 24 with an upper surface 26 and a lower surface 28. Here, the base portion 24 is formed entirely of plastic material, such as HDPE, but the base portion could be formed with internal reinforcement (e.g., metal) in some sections. A plurality of ribs 30 extend upward from the upper surface 26 of the base portion. Here, each rib 30 is formed by a metal reinforcement strip 30a within surrounding plastic material 30b. The strip 22 has opposite elongated sides 32, 34 and is wound into a tubular pipe form with the upper surface 26 and the ribs 30 at an exterior of the tubular pipe form. An edge portion 32a of the side 32 overlaps with an edge portion 34a of the opposite side 34 along a helical joint 36. A plastic seam weld 38 is applied between the overlapping portions 32a and 32b for bonding the overlapping portions together.

A plastic overweld 40 is also provided and extends over the overlapping edge portions 32a, 34a of the two sides 32 and 34. The overweld 40 also extends over both an adjacent portion 32b of side 32 and adjacent portion 34b of side 34. Portion 32b does not overlap with any part of side 34, and portion 34b does not overlap with any part of side 32. Both the seam weld 38 and the overweld 40 may also be formed of plastic material, such as HDPE, though other variations are possible.

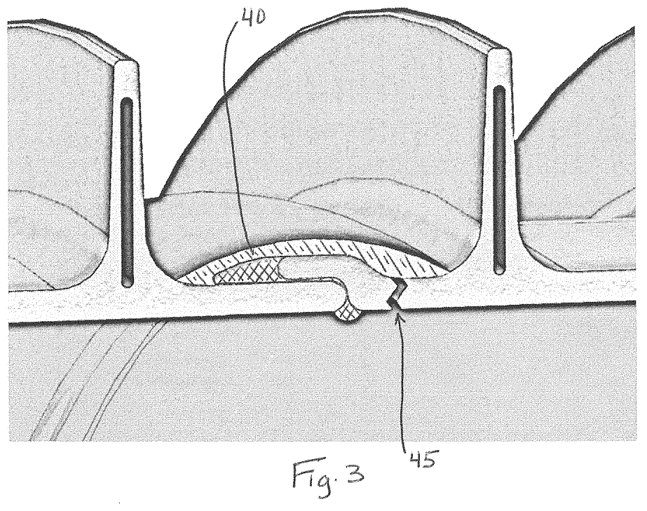

The plastic overweld 40 is bonded to the exterior facing surface of each of portion 34a, a part of the plastic seam weld 38 that is external of the overlapping portions 32a and 34b, the adjacent portion 32b and the adjacent portion 34b. As shown, the overlapping portions are between rib 30-1, which is proximate to and runs along the side 32, and rib 30-2, which is proximate to and runs along the side 34. Here, the plastic overweld 40 extends onto each of a transition region 42 from the base portion to the rib 30a and a transition region 44 from the base portion to the rib 30b. Transition region 42 is defined by a thickening T1 of plastic of the base portion and the transition region 44 is defined by a thickening T2 of plastic of the base portion. Each thickening T1, T2 defines a respective exterior outwardly curved surface segment 42a, 44a adjacent the respective rib 30a, 30b. As seen in FIG. 2, the overweld provides sound bonding of the helical joint 36 to help prevent separation of the sides 32 and 34 and overlaps the region where a fracture under extreme conditions might occur, strengthening the overall pipe structure in that region. Thus, the overweld 40 reduces the chance of fracture under the extreme conditions. Moreover, as suggested in FIG. 3, if a pipe wall fracture 45 does occur, the overweld 40 can preserve the integrity of the pipe wall.

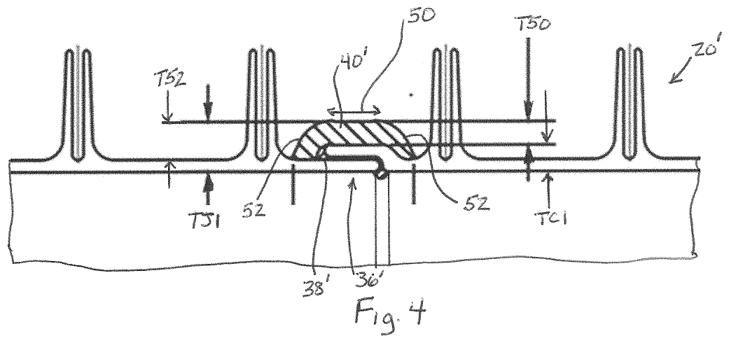

Referring now to FIG. 4, a pipe 20′ includes a seam weld 38′ and overweld 40′, where the overweld 40′ has a slightly different profile than that shown in FIG. 2. In FIG. 2, the exterior surface of the overweld 40 is generally curved across it entire width or span of the joint 36. However, in FIG. 4, the overweld 40′ of joint 36′ includes a central segment 50 that is generally planar, with a relatively uniform thickness T50. Side segments 52 of the overweld 40′ begin with a larger thickness (e.g., T52), with the thickness tapering down to the very edges of the overweld. A combined thickness of the overlapping side portions and the seam weld therebetween is shown as TC1. A combined thickness of the overlapping side portions, the seam weld therebetween and the overweld is shown as TJ1.

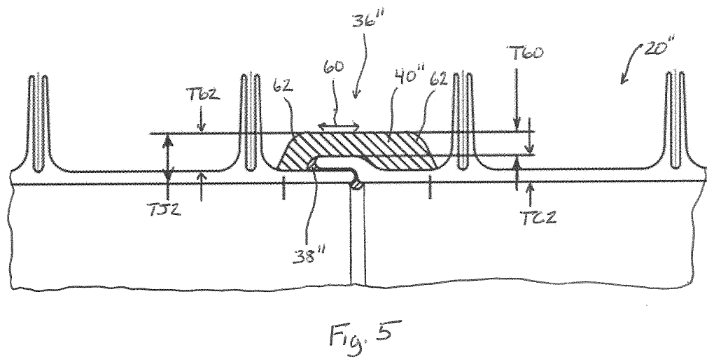

Referring now to FIG. 5, a pipe 20″ includes a seam weld 38″ and overweld 40″, where the overweld 40″ of joint 36″ includes a central segment 60 that is generally planar, with a relatively uniform thickness T60. Side segments 62 of the overweld 40″ begin with a larger thickness (e.g., T62), with the thickness tapering down to the very edges of the overweld. A combined thickness of the overlapping side portions and the seam weld therebetween is shown as TC2.

The central segment 50, 60 of the plastic overweld may have a thickness T50, T60 of at least 0.150 inches, such as at least 0.180 inches. The central segment 50, 60 of the plastic overweld may have a thickness T50, T60 that is equal to or greater than thirty percent (30%) of the combined thickness T52, T62 of the overlapping portions and the seam weld therebetween (e.g., equal to or greater than fifty percent or equal to or greater than seventy percent of the combined thickness of the overlapping portions and the seam weld therebetween). The central segment 50, 60 of the plastic overweld has a thickness T50, T60 and the adjacent side segments 52, 62 of the plastic overweld have respective side segment thicknesses T52, T62, and each side segment thickness T52, T62 is at least thirty-five percent larger than the thickness T50, T60. The foregoing relative dimensions provide advantageous joint performance.

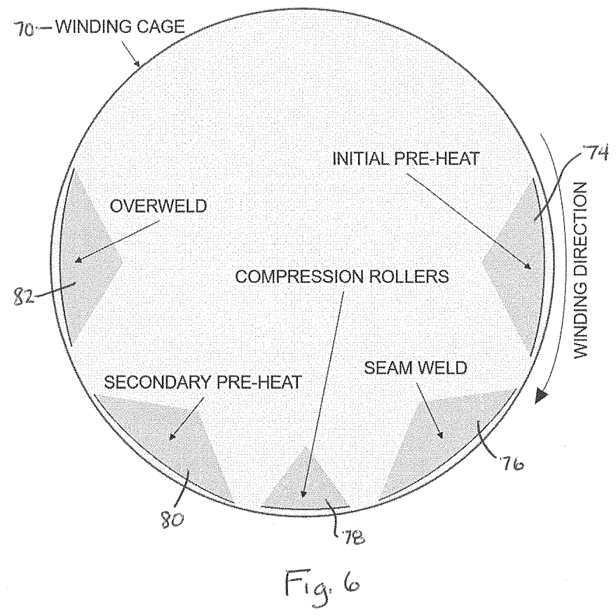

Referring now to FIG. 6, a schematic depiction of the winding operation for the composite strip shows a winding cage 70 with a winding direction 72. As the elongate composite plastic strip is wound using about the winding cage, the opposed sides of the strip are pre-heated (e.g., using heated air) in zone 74 to prepare for application of the seam weld, which occurs in zone 76. The pre-heating facilitates bonding of the plastic of the seam weld to the plastic of the sides. After application of the seam weld, the overlapping portions of the sides are brought together and pressure applied in zone 78, using compression rollers at the inner and outer sides of the joint. This application of pressure causes some plastic of the seam weld to be squeezed out beyond the overlapping side portions. In zone 80, another pre-heat occurs at the exterior face of the joint to prepare for application of the overweld, which occurs in zone 82. The overweld is applied with a pressure head the defines the exterior surface contour of the final overweld.

In FIGS. 4 and 5 above the strip is shown with upstanding ribs that do not include inserted metal reinforcement. However, in a typical pipe such ribs will include the metal reinforcement that is, typically, fully encased in plastic.

It is to be clearly understood that the above description is intended by way of illustration and example only, is not intended to be taken by way of limitation, and that other changes and modifications are possible.

What is claimed is:

1-11. (canceled)

12. A method of manufacturing helically ribbed pipe, the method comprising:
using an elongate composite plastic strip having a base portion having an upper surface and a lower surface, a plurality of ribs extending upward from the upper surface of the base portion, each rib formed by a reinforcement strip within plastic material, the composite plastic strip having a first side and a second side;
helically wrapping the composite plastic strip into a tubular pipe form with the upper surface and the ribs at an exterior of the tubular pipe form and with a first portion of the first side overlapping a first portion of the second side at a helical joint, and, during the wrapping, applying a plastic seam weld between the overlapping first portions for bonding the overlapping first portions;
applying pressure to the overlapping first portions of the first side and the second side to compress the plastic seam weld;
after the application of the pressure, applying a plastic overweld that extends over the overlapping first portions of the first side and the second side and over both a second portion of the first side and a second portion of the second side, wherein the second portion of the first side is adjacent to the first portion of the first side and does not overlap with any part of the second side, and wherein the second portion of the second side is adjacent to the first portion of the second side and does not overlap any part of the first side.

13. The method of claim 12, wherein the overlapping first portions of the first side and second side are between a first one of the ribs that is proximate the first side and a second one of the ribs that is proximate the second side, wherein the overweld extends onto a first region of transition from the base portion to the first one of the ribs and onto a second region of transition from the base portion to the second one of the ribs.

14. The method of claim 13, wherein the first region of transition is defined by a first thickening of plastic of the base portion and the second region of transition is defined by a second thickening of plastic of the base portion.

15. The method of claim 14, wherein the first thickening defines a first exterior outwardly curved surface segment adjacent the first one of the ribs and the second thickening defines a second exterior outwardly curved surface segment adjacent the second one of the ribs.

16. The method of claim 12, wherein the plastic overweld is applied so as to bond to each of: an exterior one of the first portions, a part of the plastic seam weld that is external of the overlapping first portions, the second portion of the first side and the second portion of the second side.

17. The method of claim 16, wherein the plastic overweld is applied such that a central segment of the plastic overweld has a first thickness and adjacent first and second side segments of the plastic overweld have respective side segment thicknesses, wherein each side segment thickness is at least thirty-five percent larger than the first thickness.

18. A method of manufacturing a helically ribbed pipe, the method comprising:
using an elongate plastic strip having a base portion having an upper surface and a lower surface, a plurality of ribs extending upward from the upper surface of the base portion, the plastic strip having a first side and a second side;
helically wrapping the plastic strip into a tubular pipe form with the upper surface and the ribs at an exterior of the tubular pipe form and with a first portion of the first side overlapping a first portion of the second side at a helical joint, and, during the wrapping, applying a plastic seam weld between the overlapping first portions for bonding the overlapping first portions;
after the plastic seam weld is applied, applying a plastic overweld that extends over the overlapping first portions of the first side and the second side and over both a second portion of the first side and a second portion of the second side, wherein the second portion of the first side is adjacent to the first portion of the first side and does not overlap with any part of the second side, and wherein the second portion of the second side is adjacent to the first portion of the second side and does not overlap any part of the first side.

19. The method of claim 18, wherein the overlapping first portions of the first side and second side are between a first one of the ribs that is nearest the first side and a second one of the ribs that is nearest the second side, wherein the plastic overweld extends onto a first region of transition from the base portion to the first one of the ribs and onto a second region of transition from the base portion to the second one of the ribs.

20. The method of claim 19, wherein the first region of transition is defined by a first thickening of plastic of the base portion and the second region of transition is defined by a second thickening of plastic of the base portion.

21. The method of claim 20, wherein the first thickening defines a first exterior outwardly curved surface segment adjacent the first one of the ribs and the second thickening defines a second exterior outwardly curved surface segment adjacent the second one of the ribs.

22. The method of claim 18, wherein the plastic overweld is applied so as to bond to each of: an exterior one of the first portions, a part of the plastic seam weld that is external of the overlapping first portions, the second portion of the first side and the second portion of the second side.

23. The method of claim 22, wherein the plastic overweld is applied such that a central segment of the plastic overweld has a first thickness and adjacent first and second side segments of the plastic overweld have respective side segment thicknesses, wherein each side segment thickness is at least thirty-five percent larger than the first thickness.

24. The method of claim 18, wherein a central segment of the plastic overweld is applied to result in a central sement thickness of at least 0.150 inches.

25. The pipe of claim 18, wherein a central segment of the plastic overweld is applied to result in a central segment thickness of at least 0.180 inches.

26. The method of claim 18, wherein a central segment of the plastic overweld is applied to result in a central segment thickness that is equal to or greater than thirty percent of a combined thickness of the overlapping first portions and the plastic seam weld therebetween.

27. The method of claim 18, wherein a central segment of the plastic overweld is applied to result in a central segment thickness that is equal to or greater than fifty percent of a combined thickness of the overlapping first portions and the plastic seam weld therebetween.

28. The method of claim 18, wherein a central segment of the plastic overweld is applied to result in a central segment thickness that is equal to or greater than seventy percent of a combined thickness of the overlapping first portions and the plastic seam weld therebetween.

29. The method of claim 18, further comprising:
carrying out a pre-heat step prior to application of the plastic seam weld;
after application of the seam weld, applying pressure to the overlapping first portions of the first side and the second side to compress the plastic seam weld; and
after applying pressure, carrying out a secondary pre-heat step, prior to applying the plastic overweld.
